(19) United States
(12) Patent Application Publication
(10) Pub. No.: US 2017/0098222 A1
(43) Pub. Date: Apr. 6, 2017

(54) Method for rapidly delivering rebrabded software applications and associated computer progam

(71) Applicant: William Sarris, Pebble Beach, CA (US)

(72) Inventor: William Sarris, Pebble Beach, CA (US)

(21) Appl. No.: 14/756,728

(22) Filed: Oct. 5, 2015

(51) Int. Cl. G06Q 30/02; G06Q 10/08

(52) U.S. Cl. CPC G06Q 30/0201; G06Q 10/087

(57) ABSTRACT

A method for rapidly delivering rebranded software applications and the associated computer program that repackages approved software application packages and redistributes them as new application packages using a customer's name and marketing scheme.

### FEDERALLY SPONSORED RESEARCH

Not Applicable

### SEQUENCE LISTING OR PROGRAM

Not Applicable

### BACKGROUND

Field of Invention

The present invention relates generally to the field of downloadable software applications. More specifically, the present invention relates to the rapid delivery of downloadable software applications that have been custom-branded to meet the marketing needs of a specific user.

Description of the Prior Art

### DEFINITIONS

Application—An application program (application” or “app”) is a computer program designed to perform a group of coordinated functions, tasks, or activities for the benefit of the user. Some common examples of applications include word processing applications, spreadsheets, finance and accounting applications (payroll deductions, check balancing, online banking, etc.), computer assisted drawing (“CAD”) applications, games (solitaire, minesweeper, etc.), and media players. Many of these applications are sold and included as pre-installed software; when the user purchases a personal computer (“PC”), he/she purchases these pre-installed applications as part of the original purchase. Applications that are not preinstalled are usually available for purchase from the producer of the application or an authorized distributor. These applications are typically installed by the user in his/her PC by means of a compact disc download.
Financial Technology (“Fintech”)—The national Digital Research Centre in Dublin, Ireland defines financial technology as “innovation in financial services”, adding that “the term has started to be used for broader applications of technology in the space—to front-end consumer products, to new entrants competing with existing players, and even to new paradigms.” Investopedia defines Fintech as “ . . . a portmanteau of financial technology that describes an emerging financial services sector in the 21st century. Originally, the term applied to technology applied to the back-end of established consumer and trade financial institutions. Since the end of the first decade of the 21st century, the term has expanded to include any technological innovation in the financial sector, including innovations in financial literacy and education, retail banking, investment, and even crypto-currencies like Bitcoin.” Fintech is a line of business based on using software to provide financial services such as insurance, banking, accounting, investing, etc. American financial technology companies are generally startups founded with the purpose of disrupting incumbent financial systems and corporations that rely less on software.
Mobile Application (“App”)—A mobile app is a computer program (application) designed to run on a mobile device such as a Smartphone or a tablet computer. Many of these apps are sold and included as pre-installed software such as weather and mapping software, calendars, stocks, and the like. Apps that are not preinstalled are usually available through application distribution platforms, which are typically operated by the owner of the mobile operating system such as the Apple App Store®, Google Play®, Windows Phone Store®, and BlackBerry App World®. While many mobile apps are free for the asking, others must be purchased from the vendor or producer of the app. Apps are typically downloaded from the application distribution platform to a target device, but some may be downloaded to laptop or desktop computers. For those apps with a price, an agreed-upon percentage (in the distribution platform's contract) typically goes to the distribution provider and the rest goes to the producer of the app or the vendor owning the distribution rights.
Application Package—An application package is an archive file often in the form of a zip or tar file. It is a compressed collection of files that permits the safe transmission of a collection of files in one file. The file is then unpacked (unzipped) on the receiving end so the individual contents can be used. For example, you could not email a folder or directory of files as a single attachment. Each file would need to be a separate attachment. You could package (zip, compress) all of the files into a single file (package/zip/tar/ipa/apk) and send it as a single file attachment. The receiver then unzips the file (or explodes the package) to access the files within.

A software application package typically contains three general types of files. Each package contains an executable which is compiled code (the compiled program itself). Second, there are assets such as numerous image files depicting differing sizes of an icon, different sizes of the splash screen (the entry screen that appears when first opening the application on a device). These image files depicting differing sizes of the same image are necessary so that the application is compatible multiple devices and versions. The third category is metadata. Metadata is a separate file containing information about the application such as the name and version of the executable file, the package description and package version, and dependencies which are necessary for the software to run properly. Upon installation, metadata is stored in a local package database.

Rebranding—Rebranding a software application consists of creating a new look and/or feel for an established software application in order to differentiate the rebranded product from the original. Rebranding efforts typically include, without limitation: changing the name on the software application to that of the rebranding party; replacing the logo of the original product with that of the rebranding party; customizing the packaging of the product to meet the marketing needs of the rebranding party; changing the stationery system of the product's developer to that of the rebranding party; and updating the marketing materials associated with the product to include the rebranding party's slogans, colors, spokespersons, mascots, and the like. The goal of rebranding a software application is to make it appear more relevant to needs of the rebranding party's customer's.
Software as a Service (“SaaS”)—SaaS is a software licensing and delivery model in which software is licensed on a subscription basis and is centrally hosted, typically on the Internet. SaaS provides access to software and its functions remotely as a Web-based service. It allows organizations to access business functionality at a cost typically less than paying for licensed downloadable software applications since SaaS pricing is based on a monthly fee as opposed to a much larger purchase fee. Also, because the software is hosted remotely, users don't need to invest in additional hardware. SaaS removes the need for organizations to handle the installation, set-up and often daily upkeep and maintenance.
Metadata—Metadata is Metadata is data that describes other data. Metadata summarizes basic information about data, which can make finding and working with particular instances of data easier. For example, author, date created and date modified and file size are examples of very basic document metadata. Having the ability to filter through that metadata makes it much easier for someone to locate a specific document. Metadata can be created manually, or by automated information processing. Manual creation tends to be more accurate, allowing the user to input any information they feel is relevant or needed to help describe the file. Automated metadata creation can be much more elementary, usually only displaying information such as file size, file extension, when the file was created and who created the file.

### Description of the Problem

Commercial and financial service software is a rapidly evolving sector, especially in terms of consumer-facing web and mobile applications that now process a majority or all commercial transactions (retail purchases, banking, insurance, investments, etc.). Large commercial and financial institutions can have the financial and personnel resources to build and update their own software. The remaining business entities must purchase their digital solutions from third party vendors.

Using third-party digital solutions is problematic in two major ways that both involve a specific targeted consumer audience: the age group referred to as “Millennials” who are individuals who reached adulthood around the year 2000. Commercial entities are very interested in the tastes and preferences of Millennials given the buying power of the group as a whole and its influence on consumer markets in general.

With respect to software applications, marketing research indicates that this target group is generally indifferent if not hostile to conventional advertising schemes. Further, this research indicates that this group utilizes mobile communications devices to a much larger extent than other age groups. Given the limited screen size of modern mobile communications devices and the less than hospitable attitude toward conventional advertising displayed by Millennials as a group, commercial entities have a difficult time reaching this sizable audience with conventional advertising (pop-up ads, banner space, and the like). However, the group cannot be ignored for obvious economic reasons, so these commercial entities still have to try to reach this new target group through their preferred method of communication: the mobile communication device.

The approach taken is typically through downloadable software applications, which, according to more market research, the target group will download if they are free but are reluctant, if not loathe, to pay for them. Vendors have tried offering free software applications for some basic services but require users to purchase any upgrades but this strategy has had limited success with this target group. Further, these commercial entities are fighting an uphill battle to obtain new software, receive upgrades, and rebrand it as their own.

These businesses are severely handicapped by an obsolete delivery process that typically requires a three to five year contract to lease the third party vendors' software. Further, the delivery time between acceptance and installation is quite long and turn-around times of 12 months are not uncommon. This slow delivery process precipitates slower feature updates, the introduction of new or pre-existing bugs into software, and communications breakdowns causing improperly customized software. Finally, these companies are limited from adopting the latest third party Fintech if their contracted vendor does not support it.

By way of example, launching a financial service application with an established app store would typically take one or two days. It involves creating the assets for the application and then packaging the application. It also involves capturing the numerous screen shots (for use on different devices) in different resolutions that would be needed for publishing the application on the selected app store. The application would go through a review and approval process that may require additional submissions before the application distribution platform would accept it. For branding multiple versions of the application manually, this process would have to be repeated each time, including the repackaging of the application.

If the vendor wanted to have 500 different brands of the application (each separate brand would correspond to a different customer) the vendor would have to have a separate package for each customer (i.e., create 500 individual packages). Every time a change was made to the application, the vendor would have to manually make new packages for each customer to accommodate the change (500 new packages) and then do 500 new version submissions to each application distribution platform. The more customers a vendor has, the longer it will take those customers to get their respective applications initialized. Similarly, the more customers a vendor has, the longer it will take to provide any updates or modifications to that application.

The problem is thus threefold: (1) trying to connect with a tech-savvy market that rejects traditional advertising methods; (2) trying to monetize the preferred method of reaching this group; and (3) overcoming an obsolete and burdensome delivery system for software application updates and rebranded software.

The present invention addresses this problem as a software as a service (“SaaS”) provider. It provides a software application redistribution platform that allows a business customer to select a suitable application (already approved by an application distribution platform) from its inventory and rebrand that application with that customer's name and using that customer's branding scheme. Further, the entire process would be done automatically by a rebranding program embedded within the redistribution platform. In short, the customer could purchase a financial service application one day and have it available on one or more app stores the next day.

### DRAWINGS

### Drawing Figures

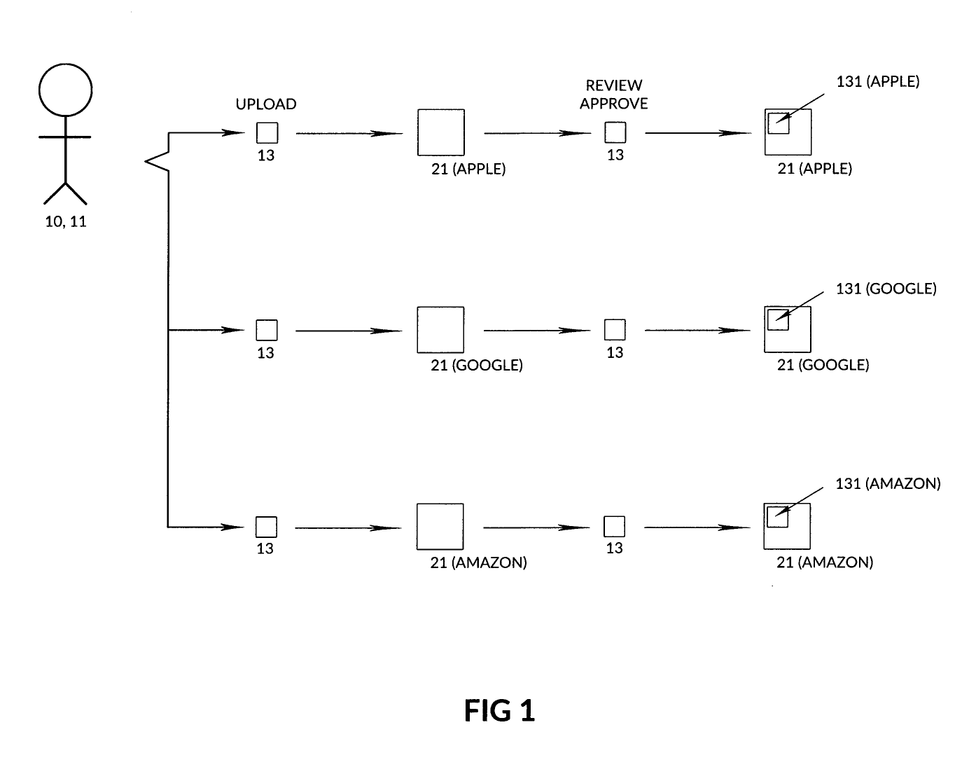

FIG. 1 is a block diagram of the preliminary steps.

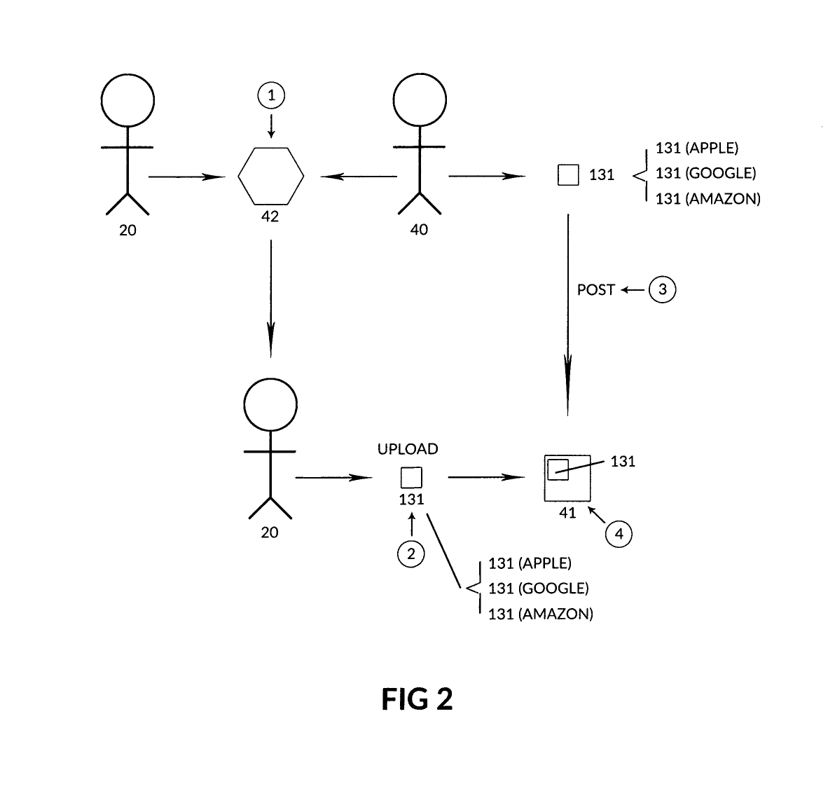

FIG. 2 is a block diagram of the steps taken by a Vendor.

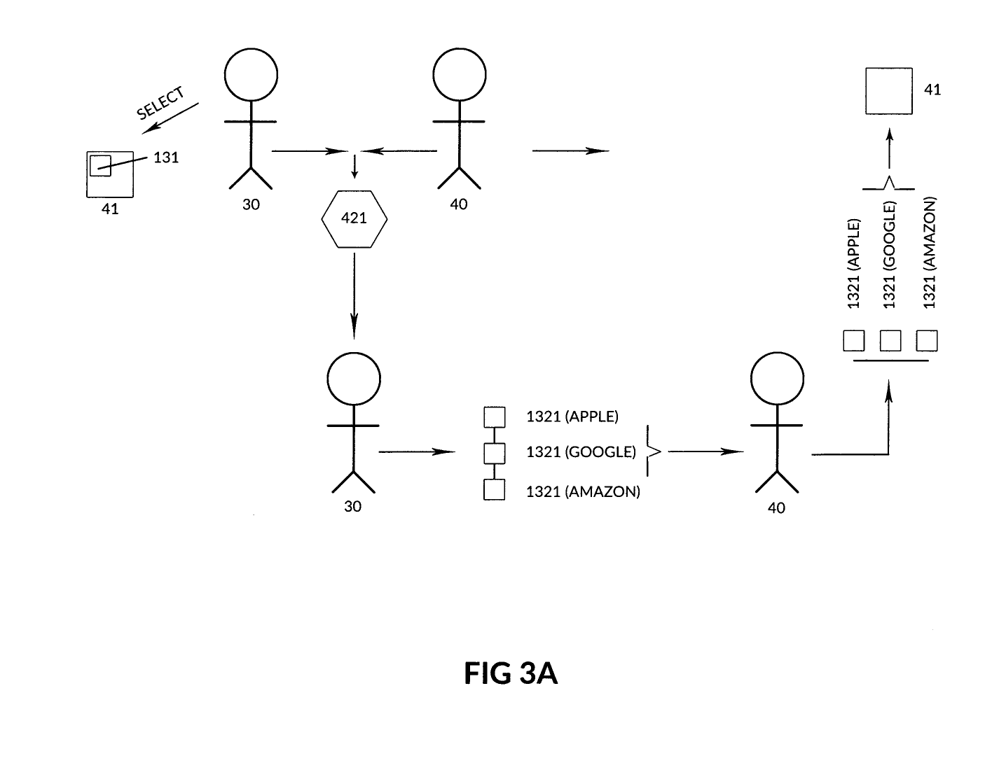

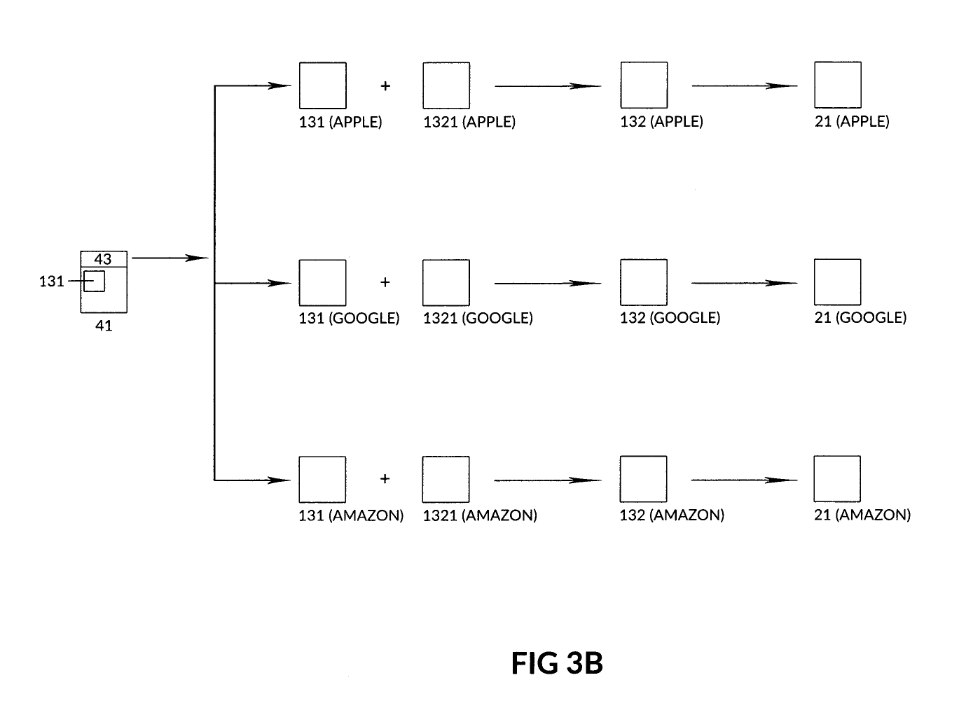

FIGS. 3A and 3B are block diagrams of the steps taken once a Customer chooses an Approved App from the Redistribution Store.

### REFERENCE NUMERALS IN DRAWINGS

10—Software application producer (“Producer”)
11—Software application rights holder (“Rights Holder”)
12—Software application (“App”)
13—Software application package
131—Approved software application package (“Approved Package”)
131E—Approved Package Executable
131A—Approved Package Asset
131M—Approved Package Metadata
132—Rebranded approved software application package (“Rebranded App”)
20—Software application vendor (“Vendor”)
21—Application distribution platform (“App Store”)
22—App Store owner
30—Software application user (“Customer”)
40—Software application rebranding entity (“Rebrander”)
41—Software application redistribution platform (“Redistribution Store”)
42—Rebranding Agreement
421—Rebrander's terms and conditions
43—Rebranding Program

### DETAILED DESCRIPTION

### Preliminary Steps

The present invention rebrands downloadable software applications (12) that have been approved and are currently available on an application distribution platform or “App Store” (21). Before the rebranding process can begin, several preliminary steps must be completed as shown in FIG. 1.

The producer (10) of a downloadable software application (12) or the person holding the production and distribution rights (11) for that application (12) uploads the application package (13) to one or more application stores (21). The owner(s) of the application store(s) (22) reviews the uploaded application package (13) to ensure that it meets the approval criteria for that (those) particular software application store(s) (21). If the application (12) and its package (13) satisfy the approval criteria for that particular store (21), the owner(s) of the store(s) (22) will approve the package(s) (13) and will include the Approved Package(s) (131) in that store's (21) online catalogue or inventory. The Producer (10) or Rights Holder (11) may repeat this process several times with several different App Stores (21) so that the App (12) will be commercially available on several App Stores (21) at the same time.

### Preferred Embodiment

The process of rapidly rebranding downloadable software applications is shown in FIGS. 2, 3A, and 3B. Referring to FIG. 2, this process begins when a Vendor (20), who could be the Producer (10) or the Rights Holder (11) acting on their own behalf or an individual who is representing the Producer (10) or the Rights Holder (11), enters into a Rebranding Agreement (42) with the Rebrander (40). Upon agreeing to the terms of the Rebranding Agreement (42), the Vendor (20) will have permission to upload its approved software application package(s) (131) to the redistribution store (41). The Rebranding Agreement (42) specifies terms and conditions permitting the Rebrander (40) to rebrand any Approved Packages (131) covered by the Agreement (42) on behalf of a Customer (30) desiring to replace the Vendor's (20) or Producer's (10) branding scheme with its own.

Having received permission through the Rebranding Agreement (42), the Vendor (20) uploads one or more Approved Packages (131) to the Redistribution Store (41) and determines the purchase price for each Approved Package (131). The Rebrander (40) then posts the Approved Package (131) and its price in the Redistribution Store's (41) online catalogue.

Referring now to FIG. 3A, a Customer (30) of the Redistribution Store (41) selects one or more Approved Packages (131) from the Redistribution Store's (41) inventory for rebranding using its own marketing materials (1321). The Customer (30) agrees to the Rebrander's (40) terms and conditions (421) (price, scope of work, etc.) and provides the Rebrander (40) with the marketing materials (1321) it needs to develop the Repackaged App (132). These marketing materials (1321) include screen images that will ultimately replace images in the Approved Package (131) and “rebrand” that Package (131) using the Customer's (30) name and marketing scheme.

These marketing materials (1321) are configured to be compatible with the requirements of each App Store (21). While FIG. 3A depicts marketing materials (1321—Apple) that would be compatible with the requirements of an Apple App Store (21—Apple), (1321—Google) for a Google App Store (21—Google), and (1231—Amazon) for an Amazon App Store (21—Amazon), the present invention contemplates accepting marketing materials (1321) compatible with any App Store (21) that the redistribution platform (41) has an agreement with. Specifically, these would be App Stores (21) that would accept applications (132) that have been “signed” [a term of art indicating that the redistribution platform [41] has a certificate from the App Store (21) authorizing it to submit applications (131) previously approved by that App Store (21)] by the redistribution platform (41).

Referring now to FIG. 3B, once the Approved Package (131) has been selected by the Customer (30) and the Rebrander's (40) terms and conditions (421) (including price) have been accepted by the Customer (30), the rebranding program (43), which is part of the redistribution store (41), unpackages the application package (13), repackages the underlying application (12) as a “repackaged” software application package (132), and then signs the rebranded application package (132). Once the rebranding process has been completed, the Redistribution Store (41) uploads the Repackaged App to the appropriate App Store (21) as a new application (12) in the Customer's (30) name using the Customer's branding scheme.

The Rebranding Program (43) repackages the underlying application (12) by modifying or replacing various marketing features appended to the underlying application (12) such as, without limitation:

(1) changing the name on the software application (12) to that of the rebranding party or Customer (30);

(2) replacing the logo of the producer (10) of the underlying application (12) with that of the rebranding party or Customer (30);

(3) customizing the packaging of the underlying application (12) to meet the marketing needs of the rebranding party or Customer (30); and

(4) updating the marketing materials associated with the underlying application (12) to include the rebranding party's (30) copy, icons, logos, and the like.

The rebranding program (43) repackages the approved package (131) automatically. It begins by unpackaging the approved package (131) into its component files: the executable (131E), the assets (131A), and the metadata (131M). The rebranding program (43) automatically substitutes the Customer's (30) marketing material (1321), which is, at minimum, a high resolution image of its icon, for the icon currently in the approved package (131). The rebranding program (43) automatically adds the number of screen shots of the marketing material (1321) required by each app store (21) that will published the repackaged application package (132). The rebranding program (43) will then automatically repackage the files (131E, 131M, and, now, 1321) into what is now a new application (132) with the Customer's (30) name and rebranding scheme.

I claim:

1. A method for rapidly rebranding a downloadable software application to meet a user's marketing needs comprising the steps of:
a. a software application vendor entering into a rebranding agreement with a rebranding entity, said rebranding agreement containing terms and conditions for rebranding a software application previously approved by an application distribution platform and added to said application distribution platform's inventory;
b. said vendor uploading said approved software application to a software application redistribution platform operated by said rebranding entity;
c. said vendor determining a retail price for said approved software application on said redistribution platform;
d. said rebranding entity posting said approved software application on said redistribution platform;
e. a customer of said rebranding entity selecting said approved software application from said redistribution platform for rebranding;
f. said customer entering into an agreement with said rebranding entity, said agreement dealing with terms and conditions for rebranding said approved software application;
g. said redistribution platform activating a rebranding program embedded within said redistribution platform;
h. said customer uploading to said rebranding program all marketing materials specified in said agreement with said rebranding entity;
i. said rebranding program unpackaging said approved software application's marketing package;
j. said rebranding program repackaging said approved software application with said customer's marketing package;
k. said rebranding program signing said approved software application with said customer's said marketing package; and
l. said rebranding program uploading said approved software application to another application distribution platform as a rebranded software application in said customer's name and using said customer's branding scheme.

2. The method as recited in claim 1, wherein said repackaging includes at least one of the following operations:
a. changing any brand names on said software application to that of said customer;
b. replacing any icon on said software application to that of said customer;
c. customizing any metadata of the said application to meet said customer's marketing needs; and
d. updating any marketing materials associated with said application to include on said customer's copy, icons, logos, and the like.

3. The method as recited in claim 1 wherein said rebranded application is distributed to more than one said application distribution platform.

4. The method as recited in claim 2 wherein said rebranded application is distributed to more than one said application distribution platform.

5. A computer program in machine readable language instructing a machine to execute the following steps in rebranding a software application previously approved by an application distribution platform, said software application having been added to said application distribution platform's inventory and subsequently uploaded to said computer program embedded in a software application redistribution platform:
a. cataloging marketing materials specified in an agreement between a rebranding entity and one of its customers desiring to rebrand said software application with said marketing materials using said customer's name and marketing scheme;
b. unpackaging said approved software application's marketing package;
c. repackaging said approved software application with said customer's marketing package comprised of said marketing materials;
d. signing said approved software application with said customer's marketing package comprised of said marketing materials; and
e. uploading said approved software application to another application distribution platform as a rebranded software application in said customer's name and using said customer's branding scheme.

6. The computer program according to claim 5 wherein said computer program instructs said machine to execute at least one of the following additional steps:
a. unpackaging more than one of said approved software application's marketing packages coming from different said application distribution platforms;
b. repackaging more than one of said approved software applications from different said application distribution platforms with said customer's marketing package comprised of said marketing materials; and
c. uploading more than one said approved software application respectively to more than one said application distribution platform as a rebranded software application in said customer's name and using said customer's branding scheme, said uploading of multiple said rebranded applications to multiple application distribution platforms based upon said rebranded application satisfying said application distribution platforms metadata requirements.
